(19) United States
(12) Patent Application Publication
(10) Pub. No.: US 2022/0167814 A1
(43) Pub. Date: Jun. 2, 2022

(54) AUTONOMOUS CLEANER AND CLEANING SYSTEM

(71) Applicant: PANASONIC INTELLECTUAL PROPERTY MANAGEMENT CO., LTD., Osaka (JP)

(72) Inventors: Tomoaki INOUE, Kyoto (JP); Koji ASAI, Osaka (JP); Yuko TSUSAKA, Kyoto (JP)

(21) Appl. No.: 17/403,449

(22) Filed: Aug. 16, 2021

(30) Foreign Application Priority Data
Nov. 27, 2020 (JP) 2020-196926

(51) Int. Cl. A47L 9/28

(52) U.S. Cl. CPC A47L 9/2852; A47L 2201/04; A47L 9/2815; A47L 9/2826

(57) ABSTRACT

An autonomous cleaner includes: a main body including a housing, a drive wheel (wheel) attached to the housing, and a drive unit that drives the drive wheel; a map storage unit that stores map information for the main body to travel; a determination unit that determines a harmful concentrated region that is likely to generate a harmful substance including at least one of a virus and a bacterium; and a map information corrector that reflects and corrects, in the map information stored in the map storage unit, the harmful concentrated region determined by the determination unit.

### BACKGROUND

### 1. Technical Field

The present disclosure relates to an autonomous cleaner that autonomously travels and cleans a predetermined space, and a cleaning system.

### 2. Description of the Related Art

For example, WO 2019/064862A (hereinafter, referred to as “Patent Literature 1”) discloses a collection device for collecting an object such as a virus or a bacterium from a floor surface as an example of an autonomous cleaner.

However, in the collection device disclosed in Patent Literature 1, in order to perform collection while uniformly traveling in a region where collection should be performed, even if there is a portion where a virus, a bacterium, or the like cannot exist in the region, an operation of collecting a virus, a bacterium, or the like is executed. That is, time required for a countermeasure may be prolonged.

### SUMMARY

The present disclosure provides an autonomous cleaner and a cleaning system capable of reducing time required for a countermeasure against a virus, a bacterium, and the like.

An autonomous cleaner according to one aspect of the present disclosure includes: a main body including a housing, a drive wheel attached to the housing, and a drive unit that drives the drive wheel; a map storage unit that stores map information for the main body to travel; a determination unit that determines a harmful concentrated region that is likely to generate a harmful substance including at least one of a virus and a bacterium; and a map information corrector that reflects and corrects, in the map information stored in the map storage unit, the harmful concentrated region determined by the determination unit.

In addition, a cleaning system according to one aspect of the present disclosure is a cleaning system including: an autonomous cleaner; and a determination device configured to freely communicate with the autonomous cleaner. The determination device determines a harmful concentrated region that is likely to generate a harmful substance including at least one of a virus and a bacterium. The autonomous cleaner includes: a main body including a housing, a drive wheel attached to the housing, and a drive unit that drives the drive wheel; a map storage unit that stores map information for the main body to travel; a communication unit that communicates with a determination device; and a map information corrector that reflects and corrects, in the map information stored in the map storage unit, the harmful concentrated region determined by the determination device and acquired via the communication unit.

According to the present disclosure, it is possible to provide an autonomous cleaner and a cleaning system capable of reducing the time required for collecting a virus, a bacterium, and the like.

### BRIEF DESCRIPTION OF THE DRAWINGS

FIG. 1 is a side view illustrating an appearance of an autonomous cleaner according to an exemplary embodiment;

FIG. 2 is a front view illustrating an appearance of the autonomous cleaner according to the exemplary embodiment;

FIG. 3 is a bottom view illustrating an appearance of the autonomous cleaner according to the exemplary embodiment;

FIG. 4 is a block diagram illustrating a characteristic functional configuration of the autonomous cleaner according to the exemplary embodiment;

FIG. 5 is a table illustrating an example of a risk degree database held by the autonomous cleaner according to the exemplary embodiment;

FIG. 6 is a table illustrating an example of a travel pattern database held by the autonomous cleaner according to the exemplary embodiment;

FIG. 7 is a flowchart illustrating processing executed by the autonomous cleaner according to the exemplary embodiment;

FIG. 8 is a flowchart illustrating map information correction processing executed by the autonomous cleaner according to the exemplary embodiment;

FIG. 9 is an explanatory diagram illustrating an example of a process when the autonomous cleaner according to the exemplary embodiment cleans a predetermined space;

FIG. 10 is an explanatory diagram illustrating a map based on map information corrected by a map information corrector according to the exemplary embodiment;

FIG. 11 is an explanatory diagram illustrating an example of a cleaning plan in a countermeasure mode according to the exemplary embodiment;

FIG. 12 is an explanatory diagram illustrating an example of a map displayed on an input unit according to the exemplary embodiment after completion of cleaning in the countermeasure mode; and

FIG. 13 is a block diagram illustrating a characteristic functional configuration of a cleaning system according to a modification.

### DETAILED DESCRIPTION

Hereinafter, exemplary embodiments of an autonomous cleaner or the like according to the present disclosure will be described in detail with reference to the drawings. Note that each of the exemplary embodiments described below illustrates a preferred specific example of the present disclosure. Therefore, numerical values, shapes, materials, components, arrangement and connection forms of the components, steps, orders of steps, etc., to be used in the following exemplary embodiments are illustrative and are not to limit the scope of the present disclosure.

Note that the attached drawings and the following description are provided for those skilled in the art to fully understand the present disclosure, and are not intended to limit the subject matter as described in the appended claims.

Further, each of the drawings is a schematic diagram, and is not necessarily strictly illustrated. Furthermore, in each of the drawings, substantially the same components are denoted by the same reference numerals, and redundant description may be omitted or simplified.

Furthermore, in the following exemplary embodiments, an expression using “substantially” such as a substantially triangular shape is used. For example, a substantially cylindrical shape means not only a completely cylindrical shape but also a substantially cylindrical shape. That is, for example, a substantially cylindrical shape also means that a cylinder including some irregularities on a surface is included. The same applies to other expressions using “substantially”.

Further, in the following exemplary embodiments, a case where an autonomous cleaner that performs cleaning by traveling on a floor of a predetermined space is viewed from vertically above may be referred to as a top view, and a case where the autonomous cleaner is viewed from vertically below may be referred to as a bottom view.

### Exemplary Embodiment

### [Configuration]

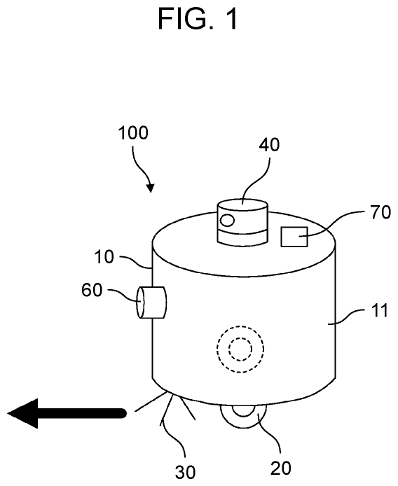

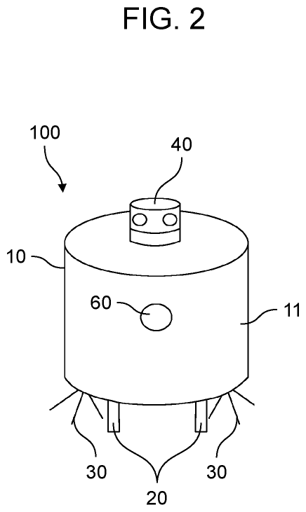

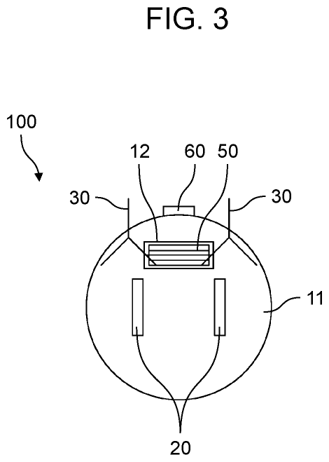

First, a configuration of autonomous cleaner 100 according to an exemplary embodiment will be described. FIG. 1 is a side view illustrating an appearance of autonomous cleaner 100 according to the exemplary embodiment. FIG. 2 is a front view illustrating an appearance of autonomous cleaner 100 according to the exemplary embodiment. FIG. 3 is a bottom view illustrating an appearance of autonomous cleaner 100 according to the exemplary embodiment.

Autonomous cleaner 100 is an autonomous cleaner that autonomously travels and cleans a predetermined space. First, autonomous cleaner 100 generates map information (data) indicating a map in a predetermined space by traveling around on a floor surface while photographing an inside of the predetermined space using camera 60 or the like.

Next, based on the generated map information, autonomous cleaner 100 calculates a travel route along which autonomous cleaner 100 travels when cleaning the predetermined space. Next, autonomous cleaner 100 travels in the predetermined space along the calculated travel route and performs cleaning.

Autonomous cleaner 100 autonomously determines whether to avoid an object (obstacle) present on a floor by observing a state in the predetermined space using camera 60 and a sensor such as a cliff sensor. When an obstacle is present, autonomous cleaner 100 leaves the calculated travel route and travels and performs cleaning while avoiding the obstacle.

Autonomous cleaner 100 generates the map information of the predetermined space to be cleaned and estimates a self-position of autonomous cleaner 100 on the map indicated by the generated map information by simultaneous localization and mapping (SLAM), for example.

Autonomous cleaner 100 includes, for example, main body 10, two wheels 20, two side brushes 30, laser distance meter 40, main brush 50, camera 60, and input unit 70.

Main body 10 accommodates components included in autonomous cleaner 100, and has cylindrical housing 11. Note that a shape of main body 10 in top view is not particularly limited. The shape of main body 10 in top view may be, for example, a substantially rectangular shape or a substantially triangular shape. As illustrated in FIG. 3, main body 10 has suction port 12 on a lower surface.

Two wheels 20 are drive wheels for causing autonomous cleaner 100 to travel, and are rotatably provided on the lower surface of main body 10.

Side brushes 30 are brushes that are provided on the lower surface of main body 10 and clean the floor surface of the predetermined space. In the present exemplary embodiment, autonomous cleaner 100 includes two side brushes 30. The number of side brushes 30 included in autonomous cleaner 100 may be one or three or more, and is not particularly limited.

Laser distance meter 40 is a sensor for measuring a distance between autonomous cleaner 100 and an object, a wall surface, or the like in the predetermined space. Laser distance meter 40 is, for example, a so-called light detection and ranging (LIDAR). Laser distance meter 40 is provided, for example, on an upper portion of main body 10.

Main brush 50 is disposed at suction port 12, and rotates to cause suction port 12 to suck dust on the floor surface.

Camera 60 is a photographing unit, and is, for example, a red, green, and blue (RGB) camera. Camera 60 is a photographing device that is disposed in a central portion of a front surface of main body 10 and generates an image by photographing the predetermined space.

Input unit 70 is disposed on an upper surface of main body 10 and behind laser distance meter 40. Input unit 70 is a portion that receives various instructions by being operated by a user. Specifically, input unit 70 is a touch panel. Therefore, input unit 70 also functions as a display unit that displays various types of information. Note that input unit 70 and the display unit may be separate bodies. Furthermore, input unit 70 may be a communication terminal such as a smartphone or a tablet terminal that can freely communicate with main body 10. In this case, main body 10 may be provided with an instrument to which the communication terminal is attachable.

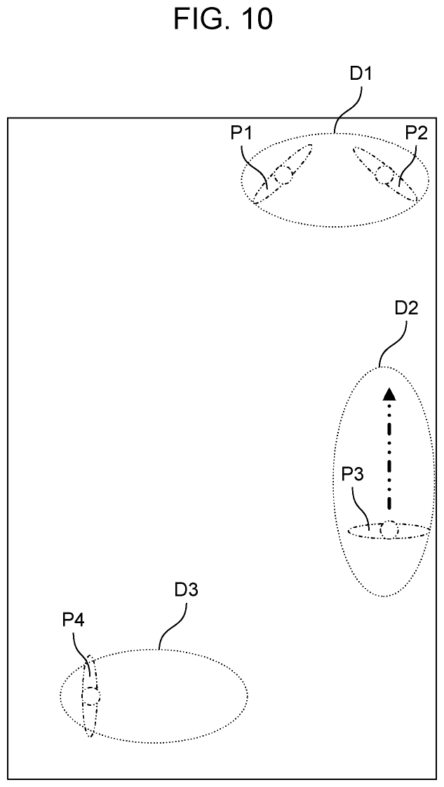

The various instructions received by input unit 70 include a normal mode and a countermeasure mode. The countermeasure mode is a mode in which autonomous cleaner 100 takes a countermeasure against harmful concentrated regions D1 to D3 described later (see FIG. 10) where a harmful substance can be generated. The normal mode is a mode in which so-called normal cleaning is executed without performing the countermeasure.

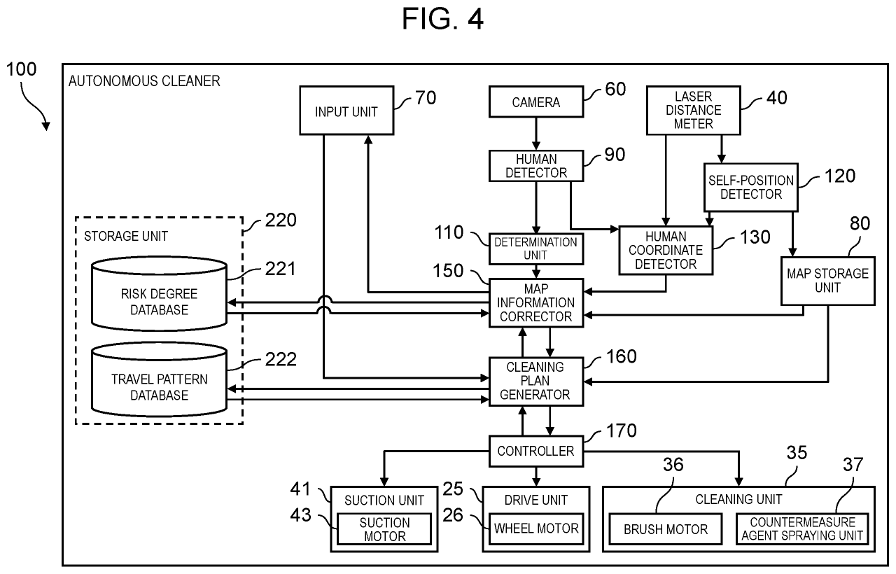

FIG. 4 is a block diagram illustrating a characteristic functional configuration of the autonomous cleaner according to the exemplary embodiment. As illustrated in FIG. 4, autonomous cleaner 100 includes laser distance meter 40, camera 60, input unit 70, map storage unit 80, storage unit 220, human detector 90, determination unit 110, self-position detector 120, human coordinate detector 130, map information corrector 150, cleaning plan generator 160, controller 170, suction unit 41, drive unit 25, and cleaning unit 35.

Map storage unit 80 stores map information generated by self-traveling of autonomous cleaner 100. The map information may be acquired from an external device. The map information includes a room layout, an obstacle, and the like in the predetermined space.

For example, human detector 90 detects a person in an image by acquiring time when the image is generated from camera 60, numerical values indicating red (R), green (G), and blue (B) of the image, an identification number (pixel number) indicating a position in the image, and the like, that is, an RGB value of each pixel from camera 60 and performing image analysis. Human detector 90 calculates a bounding box (a circumscribed rectangular frame surrounding a person) of the person included in the image, and outputs human information indicating a position (more specifically, a pixel location) of the calculated bounding box to determination unit 110 and human coordinate detector 130. Note that human detector 90 performs image processing on the image to calculate motion, orientation, and the like of the person included in the image, and incorporates the motion, orientation, and the like into the human information.

Determination unit 110 analyzes a temporal change in the human information input from human detector 90 to detect what kind of action the person included in the image is performing. Specifically, determination unit 110 detects whether the person included in the image performs a droplet-spreading action capable of spreading a harmful substance including at least one of a virus and a bacterium. Here, it is difficult to determine whether the person in the image has a harmful substance only from the human information. For this reason, in the present exemplary embodiment, assuming that the person in the image has a harmful substance, an action of spreading the harmful substance is defined as a droplet-spreading action. That is, the droplet-spreading action can also be said to be an action in which a person spreads saliva or rhinorrhea. The droplet-spreading action includes, for example, an action of not wearing a mask (first action), an action of a person coughing or sneezing (third action), an action of a person having a conversation (second action), and the like. In a case where at least one of the first action, the second action, and the third action is detected, determination unit 110 determines a predetermined region where an image on which the human information is based is photographed as harmful concentrated regions D1 to D3 in which a harmful substance can be generated. Determination unit 110 outputs determined harmful concentrated regions D1 to D3 and the actions executed in harmful concentrated regions D1 to D3 to map information corrector 150.

Self-position detector 120 detects a position of autonomous cleaner 100 in a predetermined space. For example, self-position detector 120 calculates coordinates of autonomous cleaner 100 on the map indicated by the map information, based on a distance from an object including an obstacle, a wall, or the like, which is located around autonomous cleaner 100, and input from laser distance meter 40, and the map information in map storage unit 80. Self-position detector 120 outputs self-position information indicating the detected self-position to human coordinate detector 130 in association with time of detection or the like.

Human coordinate detector 130 calculates a coordinate position of the person included in the image by compositely analyzing a detection result of laser distance meter 40, the self-position of autonomous cleaner 100 detected by self-position detector 120, and the human information input from human detector 90. For example, based on the detection result of laser distance meter 40 and the human information input from human detector 90, human coordinate detector 130 calculates relative positional relationship between the person included in the image and main body 10. Next, human coordinate detector 130 calculates the coordinate position of the person included in the image by collating the position information with the self-position of autonomous cleaner 100 detected by self-position detector 120. Human coordinate detector 130 outputs the calculated human coordinate position to map information corrector 150.

Map information corrector 150 reflects and corrects, in the map information stored in map storage unit 80, harmful concentrated regions D1 to D3 determined by determination unit 110. Specifically, many human coordinate positions are input to map information corrector 150. From these human coordinate positions, map information corrector 150 extracts the coordinate position of the person included in the image determined as harmful concentrated regions D1 to D3. Based on the extracted coordinate position of the person, map information corrector 150 reflects harmful concentrated regions D1 to D3 on the map information in map storage unit 80. At the time of reflection, map information corrector 150 sets harmful concentrated regions D1 to D3 using actions executed in harmful concentrated regions D1 to D3 and risk degree database 221 stored in storage unit 220.

Storage unit 220 is a storage device that stores risk degree database 221 and travel pattern database 222. Storage unit 220 is realized by, for example, a hard disk drive (HDD), a flash memory, or the like. Furthermore, storage unit 220 stores, for example, control programs executed by various processors such as controller 170.

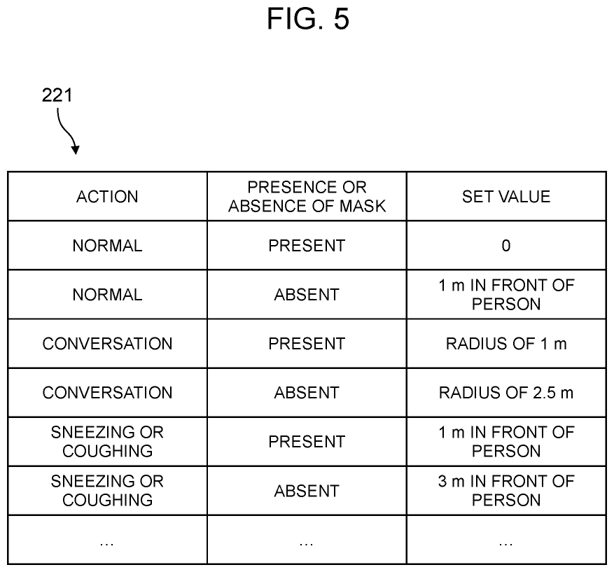

Risk degree database 221 is table information for determining a set value for each of harmful concentrated regions D1 to D3 by a combination of respective actions (first action to third action). FIG. 5 is a table illustrating an example of risk degree database 221 held by autonomous cleaner 100 according to the exemplary embodiment. In risk degree database 221, “normal” refers to a case where the second action (conversation) and the third action (sneezing or coughing) are not performed. In risk degree database 221, “conversation” refers to a case where the second action is performed. In risk degree database 221, “sneezing or coughing” refers to a case where the third action is performed. In risk degree database 221, “presence or absence of mask” indicates whether or not the action of not wearing a mask (first action) is performed, “present” indicates a case where a mask is worn, and “absent” indicates a case where a mask is not worn. In addition, in risk degree database 221, the “set value” is a value indicating a width of each of harmful concentrated regions D1 to D3 when the harmful regions are reflected in the map information.

In risk degree database 221, in a case where the person included in the image is “normal” and a mask is present, a risk of droplet-spreading is also low, and thus the set value is set to 0. In a case where the person included in the image is “normal” and a mask is absent, the risk of droplet-spreading is increased, and thus the set value is in a range of 1 m in front of the person. In a case where the person included in the image is having a “conversation” and a mask is present, the set value is in a range of a radius of 1 m based on the position information of the person. In a case where the person included in the image is having a “conversation” and a mask is absent, the set value is in a range of a radius of 2.5 m based on the position information of the person. In a case where the person included in the image is “sneezing or coughing” and a mask is present, the set value is in a range of 1 m in front of the person. In a case where the person included in the image is “sneezing or coughing” and a mask is absent, the set value is in a range of 3 m in front of the person. That is, the larger the risk of droplet-spreading is, the greater the set value is.

Map information corrector 150 outputs, to input unit 70, the map information in which harmful concentrated regions D1 to D3 are reflected based on the set value. As a result, input unit 70 displays a map in which harmful concentrated regions D1 to D3 are reflected. Further, map information corrector 150 outputs the map information in which harmful concentrated regions D1 to D3 are reflected to cleaning plan generator 160.

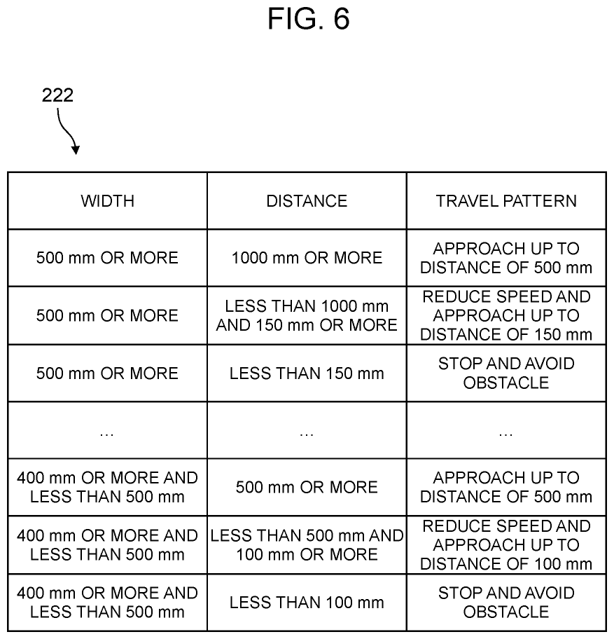

FIG. 6 is a table illustrating an example of travel pattern database 222 held by autonomous cleaner 100 according to the exemplary embodiment. In travel pattern database 222, a “width” is a width of an obstacle which main body 10 approaches, and a “distance” is a distance from main body 10 to the obstacle. Further, in travel pattern database 222, a “travel pattern” is an action of autonomous cleaner 100 toward the obstacle.

For example, when autonomous cleaner 100 approaches an obstacle having a width of 500 mm or less at a distance of 1000 mm or more, autonomous cleaner 100 thereafter performs an action of approaching up to 500 mm from the obstacle based on travel pattern database 222. Travel pattern database 222 is used when cleaning plan generator 160 generates a cleaning plan.

As illustrated in FIG. 4, cleaning plan generator 160 is a processor that generates an appropriate cleaning plan according to the normal mode or the countermeasure mode received by input unit 70. For example, cleaning plan generator 160 is a processor that generates a cleaning plan (plan information) indicating how autonomous cleaner 100 travels in a predetermined space for cleaning.

In the normal mode, based on the map information acquired from map storage unit 80, cleaning plan generator 160 generates a cleaning plan in which a travel route of autonomous cleaner 100, specifically, a travel method is determined which is a method of controlling drive unit 25 such as rotation speed of wheel motor 26 and a direction of wheels 20.

In addition, cleaning plan generator 160 generates a cleaning plan indicating a cleaning method including a method of controlling suction unit 41 (for example, a suction force, more specifically, rotation speed of suction motor 43), the method of controlling drive unit 25 such as the rotation speed of wheel motor 26 and the direction of wheels 20, a method of controlling cleaning unit 35 (for example, the number of rotations of brush motor 36), and the like. That is, in the normal mode, countermeasure agent spraying unit 37 is not driven, and a countermeasure agent is not sprayed.

On the other hand, in the countermeasure mode, based on the corrected map information acquired from map information corrector 150, cleaning plan generator 160 generates a cleaning plan in which the travel route of autonomous cleaner 100, specifically, the travel method which is the method of controlling drive unit 25 such as the rotation speed of wheel motor 26 and the direction of wheels 20 is determined. Specifically, in the countermeasure mode, a cleaning plan passing harmful concentrated regions D1 to D3 is determined.

In addition, cleaning plan generator 160 generates a cleaning plan indicating a cleaning method including the method of controlling drive unit 25 such as the rotation speed of wheel motor 26 and the direction of wheels 20, a method of controlling cleaning unit 35 (for example, the number of times of spraying by countermeasure agent spraying unit 37), and the like. That is, in the countermeasure mode, the countermeasure agent is sprayed to harmful concentrated regions D1 to D3. In the countermeasure mode, suction unit 41 and brush motor 36 may or may not be driven.

In this manner, cleaning plan generator 160 generates different cleaning plans for the normal mode and the countermeasure mode, and causes controller 170 to control autonomous cleaner 100, more specifically, suction unit 41, drive unit 25, and cleaning unit 35 based on the generated cleaning plans.

Based on the plan information generated by cleaning plan generator 160, controller 170 controls suction unit 41, drive unit 25, and cleaning unit 35 to cause autonomous cleaner 100 to autonomously travel in a predetermined space to perform cleaning.

Various processors such as human detector 90, determination unit 110, self-position detector 120, human coordinate detector 130, map information corrector 150, and controller 170 are implemented by, for example, a control program for executing the above-described processing, a central processing unit (CPU) that executes the control program, a random access memory (RAM), and a read only memory (ROM). Each of these processors may be realized by one or a plurality of CPUs.

Suction unit 41 is a mechanism for sucking dust on a floor surface of a predetermined space by sucking the floor surface. Suction unit 41 includes, for example, suction motor 43.

Suction motor 43 is connected to a fan, and sucks dust on a floor surface by rotating the fan.

Drive unit 25 is a mechanism for causing autonomous cleaner 100 to travel. Drive unit 25 includes, for example, wheel motor 26. Wheel motor 26 is connected to wheels 20 and is a motor for rotationally driving wheels 20.

Since rotation of two wheels 20 of drive unit 25 is independently controlled, autonomous cleaner 100 can perform free traveling such as going straight, moving backward, left rotation, and right rotation. Note that autonomous cleaner 100 may further include wheels (auxiliary wheels) which are not rotated by wheel motor 26.

Cleaning unit 35 is an example of a countermeasure executer that executes a countermeasure including at least one of reduction and prevention of a harmful substance by cleaning a floor surface. Cleaning unit 35 includes, for example, brush motor 36 and countermeasure agent spraying unit 37.

Brush motor 36 is a motor that is connected to a brush such as main brush 50 and drives (rotates) the brush such as main brush 50.

Countermeasure agent spraying unit 37 is a nozzle unit that sprays a countermeasure agent for inactivating a harmful substance. The countermeasure agent includes at least one of a sterilizing agent, a virus-removing agent, an antibacterial agent, and an antiviral agent.

### [Processing Procedure]

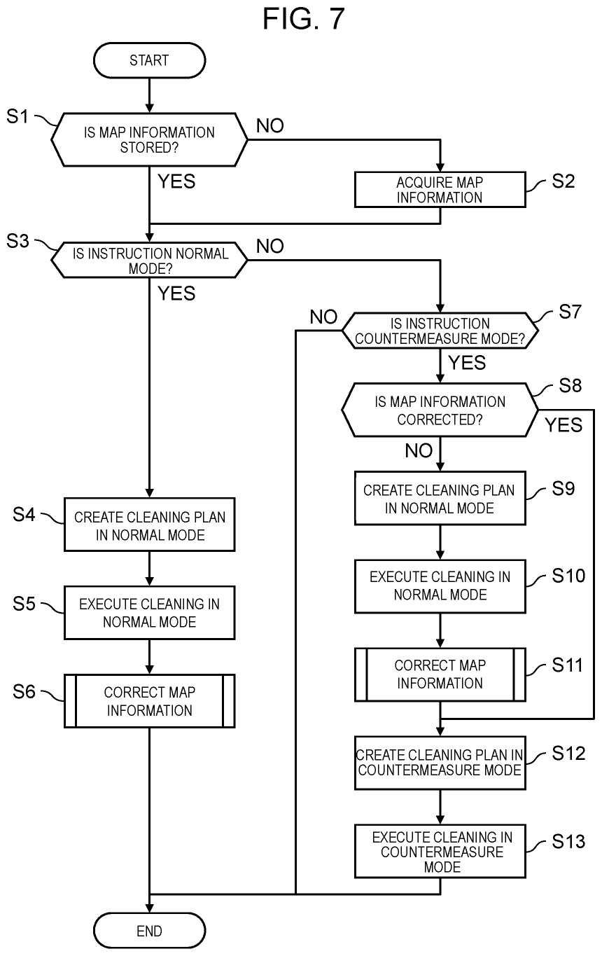

Next, an outline of a processing procedure of autonomous cleaner 100 will be described with reference to FIG. 7. FIG. 7 is a flowchart illustrating processing executed by autonomous cleaner 100 according to the exemplary embodiment.

In step S1, cleaning plan generator 160 determines whether map information is stored in map storage unit 80. In a case where the map information is not stored, the processing proceeds to step S2, and in a case where the map information is stored, the processing proceeds to step S3.

In step S2, cleaning plan generator 160 instructs controller 170 to acquire a map. By controlling drive unit 25 based on this instruction, controller 170 acquires and analyzes detection results of various sensors while causing main body 10 to travel in a predetermined space, and generates map information in the predetermined space. The generated map information is stored in map storage unit 80.

In step S3, cleaning plan generator 160 determines whether or not the instruction received by input unit 70 is the normal mode. In a case where the instruction is the normal mode, the processing proceeds to step S4. In a case where the instruction is not in the normal mode, the processing proceeds to step S7.

In step S4, cleaning plan generator 160 creates a cleaning plan corresponding to the normal mode.

In step S5, cleaning plan generator 160 executes cleaning in the normal mode based on the cleaning plan corresponding to the normal mode.

In step S6, map information corrector 150 reflects and corrects, in the map information stored in map storage unit 80, harmful concentrated regions D1 to D3 determined by determination unit 110 during the execution of cleaning in the normal mode.

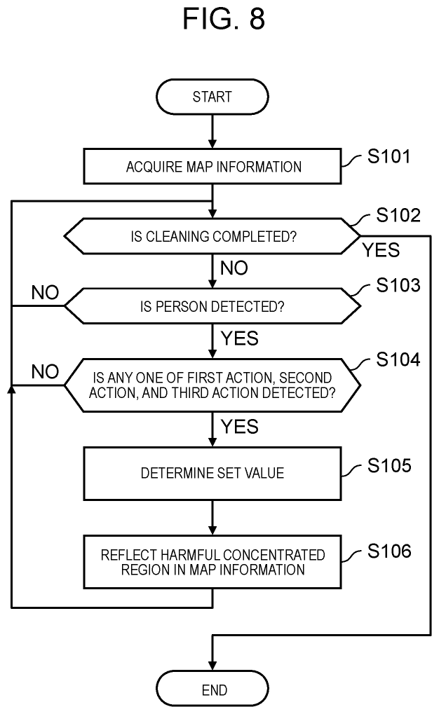

FIG. 8 is a flowchart illustrating map information correction processing executed by autonomous cleaner 100 according to the exemplary embodiment.

As illustrated in FIG. 8, in step S101, map information corrector 150 acquires map information from map storage unit 80.

In step S102, map information corrector 150 determines whether cleaning in the normal mode is completed, and ends the map information correction processing in a case where cleaning in the normal mode is completed.

In step S103, map information corrector 150 determines whether a person is detected from an image photographed by camera 60. In a case where a person is not detected, the processing proceeds to step S102. In a case where a person is detected, the processing proceeds to step S104.

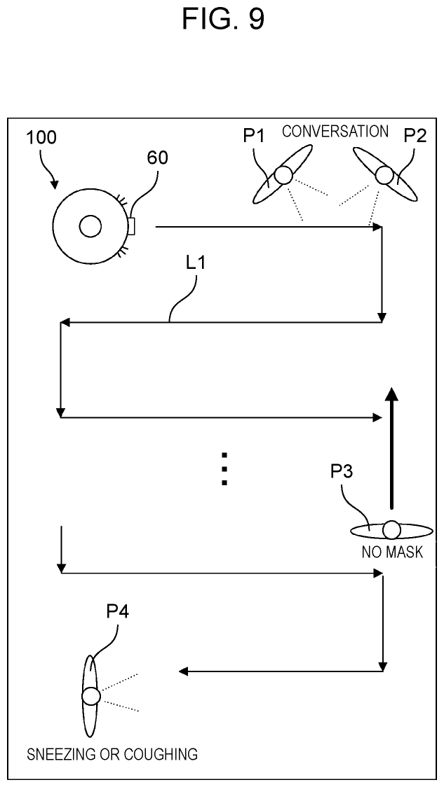

FIG. 9 is an explanatory view illustrating an example of a process when autonomous cleaner 100 according to the exemplary embodiment cleans a predetermined space. As illustrated in FIG. 9, when performing cleaning in the normal mode, autonomous cleaner 100 travels along travel route L1 corresponding to the cleaning plan. During the traveling, camera 60 of autonomous cleaner 100 photographs persons P1 to P4.

In step S104, map information corrector 150 determines whether determination unit 110 has detected any one of the first action, the second action, and the third action. In a case where any one of the first action, the second action, and the third action has not been detected, the processing proceeds to step S102. In a case where any one of the first action, the second action, and the third action has been detected, the processing proceeds to step S105. For example, in FIG. 9, persons P1, P2 are having a conversation and performing the second action. Person P3 is not wearing a mask and performing the first action. Person P4 is sneezing or coughing and performs the third action. Determination unit 110 determines predetermined regions where images including persons P1 to P4 performing these actions are photographed as harmful concentrated regions D1 to D3.

In step S105, map information corrector 150 determines a set value for each of harmful concentrated regions D1 to D3 determined by determination unit 110 based on risk degree database 221, and the processing proceeds to step S106.

In step S106, map information corrector 150 corrects the map information by reflecting the set value for each of harmful concentrated regions D1 to D3, and the processing proceeds to step S102.

FIG. 10 is an explanatory diagram illustrating a map based on the map information corrected by map information corrector 150 according to the exemplary embodiment. Note that in FIG. 10, persons P1 to P4 are indicated by two-dot chain lines for comparison with FIG. 9, but information on these persons P1 to P4 is not included in the actual map information. Map information corrector 150 causes input unit 70 to display a map based on the corrected map information. As a result, the user can visually recognize harmful concentrated regions D1 to D3.

Returning to FIG. 7, in step S7, cleaning plan generator 160 determines whether or not the instruction received by input unit 70 is the countermeasure mode. In a case where the instruction is the countermeasure mode, the processing proceeds to step S8, and in a case where the instruction is not the countermeasure mode, the processing ends.

In step S8, cleaning plan generator 160 determines whether or not the map information has been corrected. In a case where the map information has been corrected, the processing proceeds to step S12, and in a case where the map information has not been corrected, the processing proceeds to step S9.

In step S9, cleaning plan generator 160 creates a cleaning plan in the normal mode in order to correct the map information. Note that, since this cleaning plan is for the purpose of correcting the map information, driving of cleaning unit 35 may not be incorporated.

In step S10, cleaning plan generator 160 executes cleaning in the normal mode based on the cleaning plan corresponding to the normal mode.

In step S11, map information corrector 150 reflects and corrects, in the map information stored in map storage unit 80, harmful concentrated regions D1 to D3 determined by determination unit 110 during execution of cleaning in the normal mode. Specifically, in step S11, processing similar to the processing in step S6 is performed.

In step S12, cleaning plan generator 160 creates a cleaning plan in the countermeasure mode.

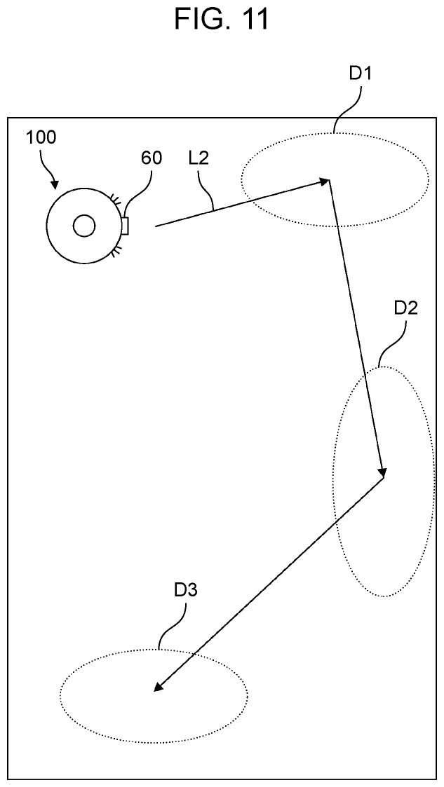

FIG. 11 is an explanatory diagram illustrating an example of a cleaning plan in the countermeasure mode according to the exemplary embodiment. As illustrated in FIG. 11, in the countermeasure mode, travel route L2 passing harmful concentrated regions D1 to D3 is generated.

Returning to FIG. 7, in step S13, cleaning plan generator 160 executes cleaning in the countermeasure mode based on the cleaning plan corresponding to the countermeasure mode. At this time, autonomous cleaner 100 sprays a countermeasure agent from countermeasure agent spraying unit 37 to each of harmful concentrated regions D1 to D3 while traveling along travel route L2 illustrated in FIG. 11. As a result, a countermeasure against a harmful substance is taken for each of harmful concentrated regions D1 to D3.

When the countermeasure against each of harmful concentrated regions D1 to D3 is completed, cleaning plan generator 160 outputs completion information to map information corrector 150. Map information corrector 150 updates the map information based on the completion information. Specifically, map information corrector 150 corrects the map information so that a display mode of each of harmful concentrated regions D1 to D3 is different from the display mode before cleaning in the countermeasure mode, and causes input unit 70 to display the map information.

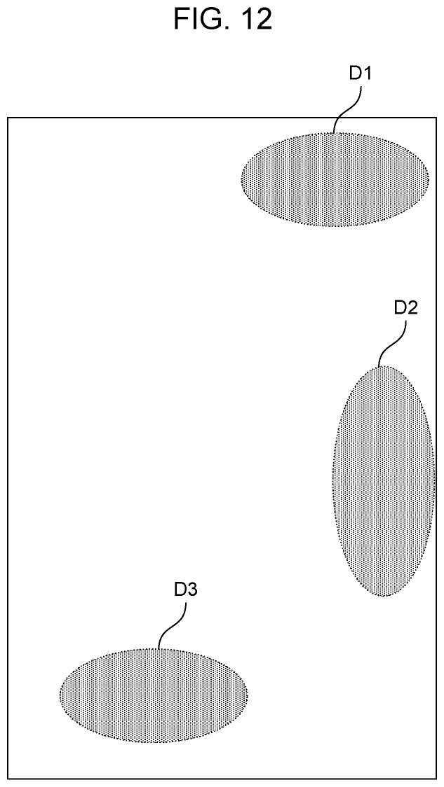

FIG. 12 is an explanatory diagram illustrating an example of a map displayed on input unit 70 according to the exemplary embodiment after completion of cleaning in the countermeasure mode. In FIG. 12, each of harmful concentrated regions D1 to D3 is displayed in a color different from the color before cleaning. As a result, the user can visually recognize whether or not a countermeasure has been taken against harmful concentrated regions D1 to D3.

### [Effects and Others]

As described above, autonomous cleaner 100 according to the exemplary embodiment includes: main body 10 including housing 11, drive wheels (wheels 20) attached to housing 11, and drive unit 25 that drives the drive wheels; map storage unit 80 that stores map information for main body 10 to travel; determination unit 110 that determines harmful concentrated regions D1 to D3 that are likely to generate a harmful substance including at least one of a virus and a bacterium; and map information corrector 150 that reflects and corrects, in the map information stored in map storage unit 80, harmful concentrated regions D1 to D3 determined by determination unit 110.

According to this configuration, since harmful concentrated regions D1 to D3 determined by determination unit 110 are reflected and corrected in the map information, it is possible to specify harmful concentrated regions D1 to D3 in the predetermined space by confirming the corrected map information. Therefore, it is possible to take an appropriate countermeasure only against harmful concentrated regions D1 to D3 without taking a countermeasure against the entire predetermined space. This makes it possible to reduce the time required for a countermeasure against a virus, a bacterium, and the like.

Further, autonomous cleaner 100 includes controller 170 that controls drive unit 25 based on the map information, and a countermeasure executer (cleaning unit 35) that executes a countermeasure including at least one of reduction and prevention of a harmful substance. Based on the map information, controller 170 controls drive unit 25 and the countermeasure executer, thereby directing main body 10 to harmful concentrated regions D1 to D3 to execute the countermeasure.

According to this configuration, since main body 10 itself moves to harmful concentrated regions D1 to D3 and executes the countermeasure, it is possible to quickly execute the countermeasure against harmful concentrated regions D1 to D3. It is also possible to reduce a risk of infection to cleaning personnel.

In addition, the countermeasure executer is cleaning unit 35 that executes the countermeasure by cleaning a floor surface.

According to this configuration, cleaning unit 35 can take the countermeasure against harmful concentrated regions D1 to D3. Here, in the present exemplary embodiment, a case has been exemplified where countermeasure agent spraying unit 37 provided in cleaning unit 35 sprays the countermeasure agent to harmful concentrated regions D1 to D3 to execute the countermeasure against harmful concentrated regions D1 to D3. However, any countermeasure may be taken against harmful concentrated regions D1 to D3 as long as the harmful substances in harmful concentrated regions D1 to D3 can be reduced and prevented. For example, other countermeasures include wiping harmful concentrated regions D1 to D3 with cloth, paper, or the like containing a countermeasure agent.

Further, main body 10 includes a photographing unit (camera 60), and determination unit 110 determines harmful concentrated regions D1 to D3 based on an image photographed by the photographing unit.

According to this configuration, since harmful concentrated regions D1 to D3 are determined based on the image photographed by the photographing unit, harmful concentrated regions D1 to D3 can be determined without collecting a harmful substance. Therefore, it is possible to suppress infection of main body 10 with a harmful substance.

Furthermore, based on the image, determination unit 110 recognizes presence or absence of at least one of actions of the person included in the image, the actions being not wearing a mask (first action), having a conversation (second action), and coughing or sneezing (third action), and determines harmful concentrated regions D1 to D3 based on the recognition of at least one of the actions.

According to this configuration, when at least one of the first action, the second action, and the third action, in which a person can spread a harmful substance, is recognized, the region where the person has been present is determined as harmful concentrated regions D1 to D3. That is, regardless of whether or not the person has a harmful substance, if an action that can spread a harmful substance is recognized, harmful concentrated regions D1 to D3 are determined, so that it is possible to take a countermeasure while a risk of infection is still small.

Further, autonomous cleaner 100 includes a display unit (input unit 70) that displays map information in which harmful concentrated regions D1 to D3 are reflected by map information corrector 150.

According to this configuration, since the map information in which harmful concentrated regions D1 to D3 are reflected is displayed on the display unit, the user can confirm the corrected map on the spot.

Note that the present disclosure may be realized as a program for causing a computer to execute steps included in a method for controlling autonomous cleaner 100. In this case, the method for controlling autonomous cleaner 100 according to the present exemplary embodiment can be easily executed by a computer.

In addition, the present disclosure may be realized as a non-transitory recording medium such as a compact disc read only memory (CD-ROM) readable by a computer in which the program is recorded. In addition, the present disclosure may be realized as information, data, or a signal indicating the program. Such a program, information, data, and signal may be distributed via a communication network such as the Internet.

### Other Exemplary Embodiments

The autonomous cleaner and the like according to the present disclosure have been described above based on the exemplary embodiment and the modification, but the present disclosure is not limited to the exemplary embodiment and the modification.

For example, in the exemplary embodiment described above, a case has been exemplified where autonomous cleaner 100 includes determination unit 110. However, the autonomous cleaner may not include the determination unit. That is, an entire cleaning system may have a function of correcting the map information.

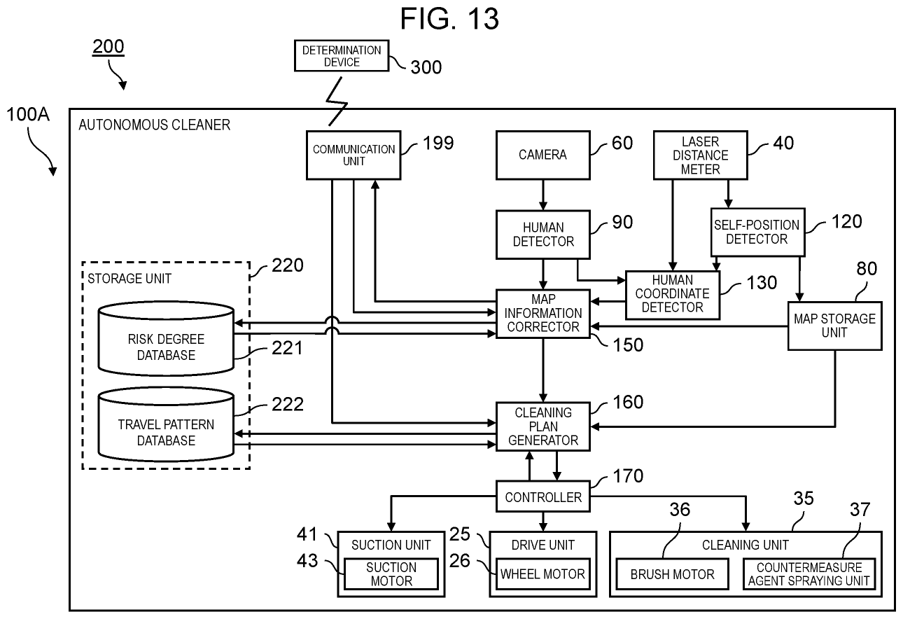

FIG. 13 is a block diagram illustrating a characteristic functional configuration of cleaning system 200 according to a modification. Specifically, FIG. 13 corresponds to FIG. 4. In the following description, the same parts as the parts in the above exemplary embodiment are denoted by the same reference numerals, and the description thereof may be omitted.

As illustrated in FIG. 13, cleaning system 200 includes autonomous cleaner 100A and determination device 300 that can freely communicate with autonomous cleaner 100A.

Determination device 300 may be, for example, a communication terminal such as a smartphone or a tablet terminal, or may be a server device connected via the Internet. In the present modification, a case where determination device 300 is a communication terminal will be exemplified. In this case, determination device 300 is mounted on autonomous cleaner 100A, and also functions as an input unit and a display unit. A camera included in determination device 300 photographs a predetermined space to acquire an image to be determined. Determination device 300 determines a harmful concentrated region by analyzing the acquired image. Determination processing is similar to the processing of determination unit 110 described above.

Note that, in a case where determination device 300 is a server device, determination device 300 is connected to a monitoring camera that photographs an image of a predetermined space, and acquires an image of the predetermined space photographed by the monitoring camera as a determination target.

Autonomous cleaner 100A has communication unit 199 that communicates with determination device 300. Communication between communication unit 199 and determination device 300 may be wireless communication or wired communication. Communication unit 199 is connected to map information corrector 150 and cleaning plan generator 160. Map information corrector 150 reflects and corrects, in the map information stored in map storage unit 80, the harmful concentrated region determined by determination device 300 and acquired via communication unit 199.

As described above, according to cleaning system 200 according to the modification, since the harmful concentrated region determined by determination device 300 is reflected and corrected in the map information, it is possible to specify the harmful concentrated region in the predetermined space by confirming the corrected map information. Therefore, it is possible to take an appropriate countermeasure only against the harmful concentrated region without taking a countermeasure against the entire predetermined space. This makes it possible to reduce the time required for a countermeasure against a virus, a bacterium, and the like.

Further, in the above exemplary embodiment, a case has been exemplified where autonomous cleaner 100 itself takes a countermeasure against harmful concentrated regions D1 to D3. However, the user may confirm the corrected map information, and the user may take a countermeasure against harmful concentrated regions D1 to D3. Alternatively, the corrected map information may be read by another countermeasure device, and a countermeasure against harmful concentrated regions D1 to D3 may be taken by the countermeasure device.

In the above exemplary embodiment, it has been described that processors such as a cleaning plan generator and a controller included in the autonomous cleaner are implemented by a CPU and a control program, respectively. For example, each of the components of the processors may include one or a plurality of electronic circuits. Each of the one or plurality of electronic circuits may be a general-purpose circuit or a dedicated circuit. The one or plurality of electronic circuits may include, for example, a semiconductor device, an integrated circuit (IC), a large scale integration (LSI), or the like. The IC or the LSI may be integrated on one chip or may be integrated on a plurality of chips. Although referred to as an IC or an LSI here, the terms vary depending on the degree of integration, and may be referred to as a system LSI, a very large scale integration (VLSI), or an ultra large scale integration (ULSI). A field programmable gate array (FPGA) programmed after manufacture of the LSI can also be used for the same purpose.

In addition, general or specific aspects of the present disclosure may be implemented by a system, a device, a method, an integrated circuit, or a computer program. Alternatively, the aspects may be realized by a computer readable non-transitory recording medium such as an optical disk, a hard disk drive (HDD), or a semiconductor memory in which the computer program is stored. Alternatively, the aspects may be implemented with any combination of the system, the device, the method, the integrated circuit, the computer program, and the recording medium.

In addition, the present disclosure also includes embodiments obtained by applying various modifications conceived by those skilled in the art to the exemplary embodiments and the modifications, and embodiments realized by arbitrarily combining components and functions in the exemplary embodiments without departing from the gist of the present disclosure.

The present disclosure is widely applicable to an autonomous cleaner that performs cleaning while autonomously moving.

What is claimed is:

1. An autonomous cleaner comprising:
a main body including a housing, a drive wheel attached to the housing, and a drive unit that drives the drive wheel;
a map storage unit that stores map information for the main body to travel;
a determination unit that determines a harmful concentrated region that is likely to generate a harmful substance including at least one of a virus and a bacterium; and
a map information corrector that reflects and corrects, in the map information stored in the map storage unit, the harmful concentrated region determined by the determination unit.

2. The autonomous cleaner according to claim 1, further comprising:
a controller that controls the drive unit based on the map information; and
a countermeasure executer that executes a countermeasure including at least one of reduction and prevention of the harmful substance,
wherein
the controller controls the drive unit and the countermeasure executer based on the map information to cause the main body to move toward the harmful concentrated region and execute the countermeasure.

3. The autonomous cleaner according to claim 1, further comprising a countermeasure executer that executes a countermeasure including at least one of reduction and prevention of the harmful substance, wherein
the countermeasure executer is a cleaning unit that executes the countermeasure by cleaning a floor surface.

4. The autonomous cleaner according to claim 1, wherein
the main body includes a photographing unit, and
the determination unit determines the harmful concentrated region based on an image photographed by the photographing unit.

5. The autonomous cleaner according to claim 1, wherein
the determination unit recognizes, based on an image photographed by the photographing unit, at least one of actions of a person included in the image, the actions being not wearing a mask, having a conversation, and coughing or sneezing, and determines the harmful concentrated region based on recognition of at least one of the actions.

6. The autonomous cleaner according to claim 1, further comprising
a display unit that displays the map information including the harmful concentrated region reflected by the map information corrector.

7. A cleaning system comprising:
an autonomous cleaner; and
a determination device configured to freely communicate with the autonomous cleaner,
wherein
the determination device determines a harmful concentrated region that is likely to generate a harmful substance including at least one of a virus and a bacterium, and
the autonomous cleaner includes:
a main body including a housing, a drive wheel attached to the housing, and a drive unit that drives the drive wheel;
a map storage unit that stores map information for the main body to travel;
a communication unit that communicates with the determination device; and
a map information corrector that reflects and corrects, in the map information stored in the map storage unit, the harmful concentrated region determined by the determination device and acquired via the communication unit.
